(19) United States
(12) Patent Application Publication
(10) Pub. No.: US 2009/0323711 A1
(43) Pub. Date: Dec. 31, 2009

(54) Service system for a building

(76) Inventor: Terence Boarer, West Sussex (GB)

Correspondence Address: Blakely Sokoloff Taylor & Zafman, 1279 Oakmead Parkway, Sunnyvale, CA, 94085-4040, US

(21) Appl. No.: 11/887,155

(22) PCT Filed: Mar. 24, 2006
(86) PCT No.: PCT/GB2006/001111

§ 371 Date: Mar. 13, 2009

(30) Foreign Application Priority Data
Dec. 6, 2004 (US) 60634161

(51) Int. Cl. H04L 12/56

(52) U.S. Cl. 370/420

(57) ABSTRACT

A control system adapted to provide an IT structure for a building. The system includes a plurality of interconnectible units each including Ethernet capability with I/O serial connections, a head end unit, and a room unit, the units being connected in series and being modular whereby to provide an IT system for a whole building. A unit for use in such a single network structure includes a first connector for supporting an in-bound feed from a source external to the unit and a second connector adapted for data distribution to a data recipient element.

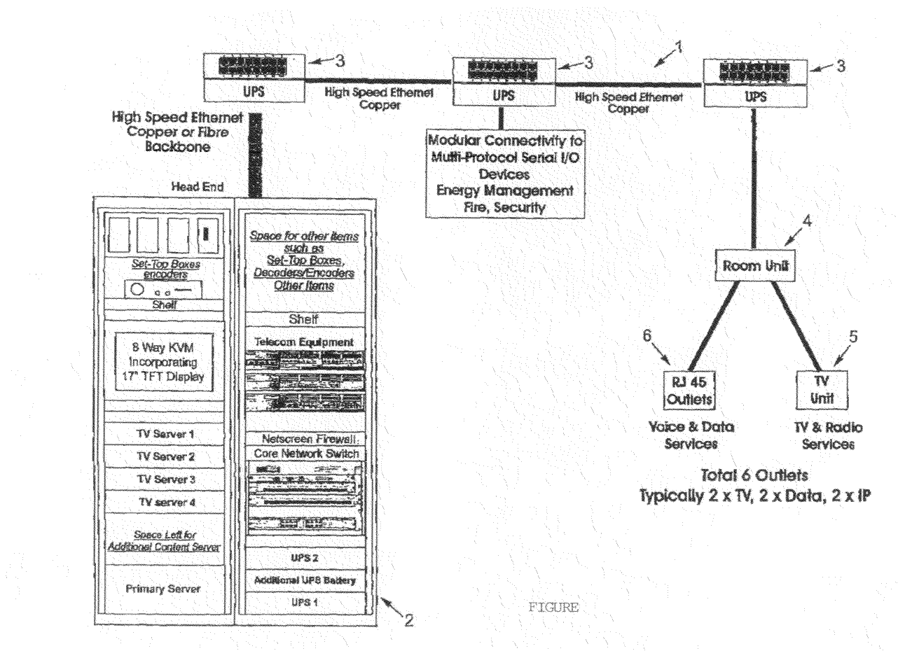

The invention relates to a services system for large buildings, particularly to such a system which can provide and control the delivery of information packets including data, voice and media packets over a common network infrastructure.

Large buildings such as hospitals, hotels, apartments, office buildings, prisons, schools, colleges and universities have multiple services systems including voice, data, TV, radio, HVAC controls and energy management systems, fire and intruder alarms, access control and CCTV. Traditionally each service system requires its own individual network and transmission protocol. Such systems are expensive to install. They are also expensive and inefficient to maintain and support.

It is an object of the invention to seek to mitigate these disadvantages.

A unit and a system incorporating same are hereinafter described, by way of example, with reference to the accompanying drawing, which shows schematically a high speed Ethernet system for providing data and the like services to a room or zone of a building.

According to the first aspect of the invention there is provided a unit for use in a single network structure, comprising a first connector for supporting an in-bound feed from a source external to the unit and a second connector adapted for data distribution to a data recipient element.

This provides a self-contained or integral unit adapted for connection to a similar unit e.g. when the external source may comprise another similar unit.

Alternatively the external source may comprise a third party Ethernet switch.

The first and second connectors may be autosense and connected by Ethernet cables, which may be crossed, or straight through.

The connectors may each comprise an RJ45 connector.

There may be a series of layer 2 protocols including IGMP v 2 and IGMP snooping within firmware of the unit.

The unit may comprise wireless Ethernet.

Suitably, the unit may comprise UPS (uninterruptible power supply), and may be mountable to a substrate. Suitably the unit may be a self-contained wall mountable box.

The unit may comprise part of a modular system including a plurality of units, each of which may have pre-defined number locked into each unit. The cables referred to may be copper cables, or fibre cables.

It will be understood that a unit may be adapted to service up to at least 80 data, voice or TV outlets, and also may be adapted to be connected in-line to a plurality of identical units per gigabit feed from a core switch.

The unit may be adapted for modular connectivity to multi-protocol serial I/O devices.

According to a second aspect of the invention there is provided a service and control system adapted to provide an IT structure for a building, comprising a plurality of interconnectible units each including Ethernet capability with I/O serial connections, a head end unit, and a room unit, the units being connected in series and being modular whereby to provide an IT system for a whole building.

The system may be adapted to be coupled to remote PCs whereby to operate and support building management(s).

The system may be incorporated into the fabric of a building, for example during refurbishment thereof.

In the system, the head-end unit may comprise one or more of an IP TV server, Data servers, IP voice system, Ethernet layer 3 core switch, a Firewall, UPS and KVM, in any combination. The system may further include a media server adapted for video provision. Moreover, the IP TV server may be connectible to a digital TV source such as a satellite source.

The Firewall may be connectible to an ADSL line to allow remote support or delivery of content In the system the interconnectible units may comprise IP-zone(s), which may each comprise a 16-port layer 2 switch including an RS485 serial I/O distribution unit.

Each zone unit may comprise a dedicated UPS and may suitably be an integral unit adapted for modular connection into the system.

The individual integral units may be connectible with a plurality of substantially identical units per gigabit feed from a core switch.

There may be a plurality of room units, each associated with a particular room of a building. Each room unit may be an IP-room unit which may comprise a multi-port Ethernet switch in a standard electrical 2-gang wall switch, suitably a 7-port Ethernet switch.

The IP-room unit may comprise a box mountable on a substrate, suitably a wall, (of a building).

The IP-room unit may comprise a plurality of outlets some of which may be adapted to be powered over the Ethernet for use with IP telephones and TV outlets.

There may be a maximum of six outlets, a maximum of two of which are adapted for power over the Ethernet for use with a maximum of two IP telephones and TV outlets.

The IP-room unit may be connectible to at least one of the IP-TV unit and voice and data services, particularly the IP-room unit being connectible to an IP-TV unit and a unit providing voice and data services.

The TV unit may comprise a miniature, low energy PC board or set top box at each TV connection point.

The PC board may be mounted on a wall mountable box at each TV outlet point.

Each TV unit may provide wireless capability, and may be supplied with multi-cast and application software and an infrared remote control handset.

Suitably the telephone and data outlets may comprise standard RJ45 outlets, which may be provided with power over Ethernet (POE).

Suitably, the said outlet may comprise two outlets per IP-room unit whereby to supply IP telephone handsets.

In one embodiment, the system may be adapted to accommodate analogue telephone handsets, for example for use in bathrooms. The IP-core head end unit may comprise a 19″ rack.

According to a third aspect of the invention there is provided a building including a unit or system substantially as hereinbefore defined.

Referring to the drawing, there is shown an Ethernet system which is modular, and comprises a head-end unit connected to a plurality of IP zone units or elements in series and which in turn connect with a room unit.

The system is based on a high speed copper or fibre back bone, and each IP-zone unit may be supplied by UPS and be connected by a single cable, in the embodiment herein, of copper. The system provides a fully convergent, industry standard IT system adapted to deliver data, voice, TV and video services over a common Ethernet network using standard TCP/IP controls. The system is fully modular, its components being built into the fabric of the building in which it is installed, either during ‘new’ building or as part of a refurbishment project. Thus a system embodying the invention provides an IT infrastructure for a building, and is adapted to be shared with other operating systems or applications providing they are designed to work on Ethernet. This provides flexibility to an occupant of a building as that occupant can provide its own IT servers, software and devices, or provide specialist services such as in-room entertainment or property management over the network provided by a system embodying the invention.

The system provides services which can include

Multicast Digital TV

Multicast Digital Radio

Multimedia Content (Films etc)

Voice over IP

PC Data Services

Secure Broadband Services

Connectivity to back office systems

Connectivity to Building Management system

Connectivity to 3^{rd} Party Proprietary I/O devices including Fire Alarms, security systems, emergency lighting, nurse call systems.

Maintenance of the system can be carried out remotely, thereby reducing maintenance overheads. Moreover, the system embodying the invention can have the ability to capture and store all events occurring in the system, and report, thereby, for example, enabling faults to be quickly remedied.

The system 1 comprises an IPiN system including an IP head-end unit 2, an IP-zone unit 3, an IP-room unit 4, an IP-TV unit 5 and telephone and data outlets 6. The items 4, 5 and 6 are located in a room, the item 5 providing TV and radio services and the item 6 voice and data services via RJ45 outlets. Generally there will be six outlets per room, two TV, two data and 2 IP telephones.

Referring to items of the system, there are the following in a system 1 configuration:—

### The IPiN Head-End 2:

A 19″ rack containing IPTV servers (connected to satellite or other digital TV source), IP voice system, Ethernet Layer 3 Core Switch, Firewall (connected to appropriate ADSL line), UPS and KVM. An optional media server can also be included for video if required.

### IP-Zone Unit 3:

Combines a 16-port layer 2 switch with an RS485 serial I/O distribution unit with its own UPS. The Zone Unit is designed to service up to 80 data, voice or TV outlets through a maximum of 13 Room Units. Zone units can be connect in-line with up to 3 Zone units per gigabit feed from the core switch. This configuration greatly reduces cabling requirements over normal IT systems where each outlet is individually cabled to a port at the edge switch.

### IP-Room Unit 4:

The Room Unit is a 7-port ethernet switch mounted in the wall behind a twin RJ45 outlet in a standard electrical 2-gang wall box. It can provide 6 outlets, a maximum of 2 of which can have power over ethernet for use with a maximum of two IP telephones and TV outlets.

### IP-TV Unit 5:

The TV Unit comprises a miniature, low energy PC board or set top box mounted in a wall box at each TV point. The cover plate has a TV outlet facilitating the use of any commercially available television. LCD televisions with stereo speakers are strongly recommended to take full advantage of the quality of fully digital IPTV and radio. Each TV Unit has wireless capability and is supplied with multicast and application software and an infra red remote control handset.

### Telephone & Data Outlet 6:

Standard RJ45 outlets are finished to match the Room and TV units. They can also be matched to light switches and power sockets. Power over ethernet (POE) can be supplied to two outlets per Room Unit to supply IP telephone handsets. In a further embodiment, analogue telephone handsets can be accommodated, for example in bathroom applications.

The head-end unit 2 provides as modules

Multicast IP Digital TV

Multicast Digital Radio

Interactive Media content

Voice over IP (VOP)

Fast Ethernet/Fibre Distribution

Power Protection

Serial I/O Device Control

3^{rd} Party Modules including:

Site Specific Media Content

Building Management Services

Hotel, Hospital or the like Back Office Systems.

The zone units 3 are each a self contained wall mounted box designed to offer a fully integrated Ethernet Switch and connectivity to 3^{rd} Party devices, using a series of modular attachments and software language protocols.

Each Zone Unit 3 presents RJ45 sockets far Data distribution and modular and static connectors that will be for additional serial I/O devices. Power is 24V DC Power Supply designed to be pluggable to assist prompt repair.

Two RJ 45 connectors are provided one supporting the in-bound feed from an external source which could be another Zone Unit or from a third party Ethernet switch. The second will be an output port which can be used to connect further Zone Units. The in-bound and Out-bound ports need to auto-sense and use crossed or straight through Ethernet cables (MDI/MDIX).

The unit will incorporate a series of Layer 2-protocols including IGMP v2 (Internet Group Management Protocol) and IGMP snooping within the firmware. Software management will be required for unique addressing the switch (IP Protocol), reporting, VLAN (Virtual Local Area Network), QOS and specific site configurations as repaired.

A provision for Wireless Ethernet may be added to the Zone Unit.

These low voltage units 3 may also be equipped with a UPS (Uninterruptible Power Supply) for added power protection.

It will be understood that the IP Zone units 3 are interconnected in a modular manner. Thus the relevant software will be programmed in such a way as to permit simple addition and subtraction of other Zone units 3. There also is the ability to configure and amend the I/O serial ports. By adding software control to devices such a Zone Units 3 and Room Units 4 the stock management of sites 2 enhanced as all of the items have a unique address, therefore it will always be known which items are in use and where they are located.
Zone Units 3 will have a pre-defined number locked into each unit and stored into the site database (Zone Unit 1, Zone Unit 2 etc).
Zone Units 3 will use a unique address and have an assigned IP address.
A configuration file will be generated for each site for use on the Zone Units; the file contains all information relevant to the location as well as a detailed list of all devices attached by port. The configuration file will be amended and setup via the “Zone Unit configuration Utility”, which can be used remotely, from an Engineers computer or from any Windows XP based workstation.
An identical configuration file will be saved to all Zone Units and can be applied immediately or automatically at an agreed scheduled time.
When amending a site the current configuration will be loaded, as a part of the “Zone Configuration Utility” from the highest available Zone Unit (Zone 1, Zone Unit 2), this will avoid an earlier version being applied accidentally.
Replacement Zone Units when installed will load the configuration file from the site automatically from the highest available Zone Unit (Zone Unit 1, Zone Unit 2).
New Units can be added to any site and an updates configuration, including the new unit, can be added remotely or on site.
The “Zone Unit Configuration Utility” will have the ability to add, amend and remove additional input/output devices running directly from the Zone Unit.
The “Zone Unit Configuration Utility” will have the ability to assign ports to specific Room Units.

To achieve this simply a database and configuration tool will be produced and are used to enable the user to configure a Zone Unit and set up all peripheral assignments.

The configuration utility will be accessed via a XP based terminal attached to the network or using an engineers network. This device will have a simple programme which loads automatically the latest configuration file from Zone Unit 1, if not available Zone Unit 2 and so on.

It will be understood that each room unit 4 is a self contained 6 port switch, mounted into the profile of a conventional flush mounted electrical dual gang socket. It has been designed to handle local distribution of Data, Multimedia Services, and Voice.

Each Room Unit 4 supports Power over Ethernet and offers power to connected Power over Ethernet connected devices, such as IP Phones for Voice over IP.

Other ports offer local distribution of services such as:

Multimedia Services; IP Multicast Digital TV, Digital Radio, and Multimedia Content;

Data: Broadband, Local Area Network, 3^{rd} Party Services and Applications.

The TV unit is designed to deliver Multicast Digital TV to the majority of available TV sets (analogue or digital).

It has compact electronics and is secured into a flush mounted chassis in a convenient, secure and discreet area, usually behind the TV set. The unit is connected via Ethernet, Wireless Ethernet, or Power over Ethernet back to the Room Unit, Zone Unit or 3^{rd} Party Ethernet Switch.

The unit captures a requested Multicast Stream for the required Digital TV Channel. It assembles the IP packets back to the original raw MPEG 2 Digital output and delivers it to the TV Set.

A remote control is provided for ease of use.

To summarise, a system embodying the invention and described with reference to the drawings has
Voice, data & video over same IP Ethernet network, now with TV and radio at no extra cost compared with conventional TV systems. Saves the use of multiple discrete networks. Ideal for all new buildings such as hospitals, hotels, apartments, office buildings, prison, schools, colleges, universities etc
System is built into the fabric of the building for durability and reliability.
System uses specially designed Zone Units and Room Units to simplify cabling and to reduce costs.
The Zone Unit has connections for both simple I/O devices and ethernet connections.
The Room Unit is an ethernet switch built into the wall in each room providing connectivity for up to 6 data, telephone or TV outlets.
The TV Unit is a miniature, low energy PC or set top box built into the wall of the room at each TV location providing outputs for any CRT, LCD or Plasma TV.
The TV Unit can also include a wireless receiver/transmitter for laptops and other portable devices.
System can be managed remotely from any PC over the internet with built-in access control and management systems.
Ability for network to also carry Building Management Systems—energy management (HVAC and lighting), security (access control, CCTV and intruder alarm systems), fire (fire alarm systems, smoke alarms, emergency lighting).
These can either be compatible systems based upon industry standard, global IP protocols or incompatible systems using protocols such as Lonworks, ETBA and BACNet via translator gateways.
Network can be used by service providers (in-room entertainment, property management systems, fire and intruder alarm systems etc) as long as they use Microsoft based operating software systems.
Applicability to Nurse Call System in hospitals.

1. A unit for use in a single network structure, comprising a first connector for supporting an in-bound feed from a source external to the unit and a second connector adapted for data distribution to a data recipient element.

2. A unit according to claim 1, the external source comprising another similar unit.

3. A unit according to claim 1, the external source comprising a third party Ethernet switch.

4. A unit according to any preceding claim, the data recipient element comprising at least one similar unit.

5. A unit according to any preceding claim, the first and second connectors being autosense and connected by Ethernet cables.

6. A unit according to claim 5, the cables being crossed.

7. A unit according to claim 5, the cables being straight through.

8. A unit according to any preceding claim, the connectors each comprising an RJ45 connector.

9. A unit according to claim 8, comprising a series of layer 2 protocols including IGMP v 2 and IGMP snooping within firmware of the unit.

10. A unit according to any preceding claim, comprising wireless Ethernet.

11. A unit according to any preceding claim, comprising UPS (uninterruptible power supply).

12. A unit according to any preceding claim, mountable to a substrate.

13. A unit according to claim 12, comprising a self-contained wall mountable box.

14. A unit according to any preceding claim, comprising part of a modular system including a plurality of units.

15. A unit according to claim 14, the units each having a pre-defined number looked into each unit.

16. A unit according to any of claims 5 to 15, the cables being copper cables.

17. A unit according to any of claims 5 to 15, the cables being fibre cables.

18. A unit according to any preceding claim, adapted to service up to at least 80 data, voice or TV outlets.

19. A unit according to claim 18, adapted to be connected in-line to a plurality of identical units per gigabit feed from a core switch element.

20. A unit according to claim 19, adapted for modular connectivity to multi-protocol serial I/O devices.

21. A unit for use in a single network structure, substantially as hereinbefore described with reference to the accompanying drawings.

22. A service and control system adapted to provide an IT structure for a building, comprising a plurality of interconnectible units each including Ethernet capability with I/O serial connections, a head end unit, and a room unit, the units being connected in series and being modular whereby to provide an IT system for a whole building.

23. A system according to claim 22, adapted to be coupled to remote PCs whereby to operate and support building management system(s).

24. A system according to claim 22 or 23, incorporated into the fabric of a building.

25. A system according to claim 24, incorporated into the fabric of a building during refurbishment thereof.

26. A system according to any of claims 22 to 25, the head-end unit comprising one or more of an IP TV server, IP voice system, Ethernet layer 3 core switch, a Firewall, UPS and KVM, in any combination.

27. A system according to claim 26, further including a media server adapted for video provision.

28. A system according to either of claims 26 or 27, the IP TV server being connectible to a digital TV source.

29. A system according to claim 28, the source comprising a satellite source.

30. A system according to any of claims 26 to 29, the Firewall being connectible to an ADSL line.

31. A system according to any of claims 22 to 30, the interconnectible units comprising IP-zone units.

32. A system according to claim 31, the IP-zone units each comprising a 16-port layer 2 switch including an RS485 serial I/O distribution unit.

33. A system according to claim 31 or claim 32, each unit comprising a dedicated UPS.

34. A system according to claim 33, each IP-zone unit being an integral unit adapted for modular connection into the system.

35. A system according to claim 34, individual integral units being connectible with a plurality of substantially identical units per gigabit feed from a core switch.

36. A system according to any of claims 22 to 35, there being a plurality of room units, each associated with a particular room of a building.

37. A system according to claim 36, each room unit being an IP-room unit comprising a multi-port Ethernet switch in a standard electrical 2-gang wall switch.

38. A system according to claim 37, the switch comprising 6-port Ethernet switch.

39. A system according to claim 37 or claim 38, the IP-room unit comprising a box mountable on a substrate.

40. A system according to claim 39, the substrate comprising a wall.

41. A system according to any of claims 37 to 40, the IP-room unit comprising a plurality of outlets some of which are adapted to be powered over the Ethernet for use with IP telephones and TV outlets.

42. A system according to claim 41, there being a maximum of six outlets, a maximum of two of which are adapted for power over the Ethernet for use with IP telephones and TV outlets.

43. A system according to any of claims 37 to 42, the IP-room unit being connectible to at least one of the IP-TV unit and voice and data services.

44. A system according to claim 43, the IP-room unit being connectible to an IP-TV unit and a unit providing voice and data services.

45. A system according to claim 43, or claim 44, the TV unit comprising a miniature, low energy PC board or set top box at each TV connection point.

46. A system according to claim 45, the PC board being mounted on a wall mountable box at each TV outlet point.

47. A system according to any of claims 44 to 46, each TV unit providing wireless capability.

48. A system according to claim 47, the TV unit being supplied with multi-cast and application software and an infrared remote control handset.

49. A system according to any of claims 43 to 48, the telephone and data outlets comprising standard RJ45 outlets.

50. A system according to claim 49, the said outlets being provided with power over Ethernet (POE).

51. A system according to claim 50, the said outlets comprising two outlets per IP-room unit whereby to supply IP telephone handsets.

52. A system according to any of claims 22 to 51, the IP head end unit comprising a 19″ rack.

53. A service and control system, substantially as hereinbefore described with reference to the accompanying drawing.

54. A building including a unit or system substantially as hereinbefore described with reference to the accompanying drawing and/or as claimed in any of the preceding claims.
